(19) United States
(12) Patent Application Publication
(10) Pub. No.: US 2024/0386113 A1
(43) Pub. Date: Nov. 21, 2024

(54) DETECTING AND PREVENTING CODE EXECUTION VULNERABILITY

(71) Applicant: Cisco Technology, Inc., San Jose, CA (US)

(72) Inventor: Abhishek Singh, Morgan Hill, CA (US)

(21) Appl. No.: 18/198,138

(22) Filed: May 16, 2023

(51) Int. Cl. G06F 21/57; G06F 21/52; G06F 21/55; G06F 21/56

(52) U.S. Cl. CPC G06F 21/577; G06F 21/52; G06F 21/552; G06F 21/566; G06F 2221/033

(57) ABSTRACT

Techniques are described for protecting services containing web applications from malicious attacks. A data flow that includes a stack trace and a process is received from a web application. The stack trace is chained with the process to generate a data flow graph. A data lake is then accessed to determine whether the data flow graph is in the data lake. If the data flow graph is not in the data lake, then the data flow can be considered safe. If the data flow graph is not already in the data lake, then a determination is made as to whether the data flow includes a command that accepts user input. If it is determined that the data flow does include a command that accepts user input, then the data flow can be considered to be malicious and the process is terminated to protect the web application from a malicious attack.

### TECHNICAL FIELD

The present disclosure relates generally to preventing remote code execution vulnerability in web applications.

### BACKGROUND

A web application is an application program that is stored on a remote server and delivered over a network such as the Internet through a browser interface. Web services are web applications by definition and many websites contain web applications.

Developers design web applications for a wide variety of reasons. Commonly used web applications can include webmail, online calculators or e-commerce shops. While users can only access some web applications by a specific browser, most are available no matter the browser used.

Web applications do not need to be downloaded since they are accessed through a network. Users can access a web application through any of various available browsers. For a web application to operate, it needs a web server, applications server and a database. Web servers manage the requests that come from a client, while the application server completes the requested task. A database stores any necessary information.

Web Applications typically have short development cycles and small development teams. Developers write most web applications in JavaScript, HTML5, or CSS. Client-side programming typically utilizes these languages, which help build an application's front-end. Server-side programming creates the scripts that a web application will use. Languages such as python, Java, and Ruby are commonly used in server-side programming.

Web applications have many benefits. For example, multiple users can access the same version of an application. Also, users don't need to install the application locally on their device. In addition, users can access the application through various platforms such as a desktop, laptop or mobile device. In addition, users can access the application through multiple browsers.

Within the mobile computing sector, web applications are sometimes contrasted with native applications, which are applications developers build specifically for a particular platform or device and install on that device. Native applications can commonly make use of device-specific hardware, such as a GPS or camera on a mobile native application.

Programs that combine the two approaches can be referred to as hybrid applications. Hybrid applications work in a manner similar to web applications but install to the device as a native application would. Hybrid applications can also take advantage of device-specific resources by using internal Application Programing Interfaces (APIs). Downloaded native applications can sometimes operate offline. However, hybrid applications do not have this functionality. A hybrid application will typically share similar navigation elements to a web application since they are primarily based on web applications.

Application agents instrument the web applications and track the code flow. In the case of web applications, many vulnerabilities lead to the execution of commands in the operating system, such as Remote Code Execution (RCE) vulnerability, Operating System (OS) injection vulnerability, insecure deserialization vulnerability, and exploit code leading to web shells.

If there is data flow from methods that accept user inputs such as GET, POST, etc., to program execution functions such as long. Runtime.getRuntime( ).exec, and if the input data from GET, POST, which is an argument to the program execution function, has delimiters followed by a command, it can be determined that a flow is malicious and that the vulnerability is exploited. Terminating the vulnerable web application process may lead to crashing the application. When program execution functions are invoked, the system agent will spawn a process to execute the command or binary of the threat actor: the system agent can terminate the spawned process. However, it does not have visibility that the process getting spawned by invoking program execution functions from the web application is malicious or benign.

Endpoint Detection and Response (EDR) is a form of endpoint protection that uses data collected from endpoint devices to understand how cyberthreats behave and the ways that organizations respond to cyberthreats. While some forms of endpoint protection are focused purely on blocking threats, endpoint detection and response provides a more holistic approach. Through continuous endpoint monitoring and rigorous data analysis businesses can gain a better understanding of how one threat or another infects an endpoint device and the mechanisms by which it can spread across a network. Instead of remediating threats offhand, organizations can use the insights gained via EDR tools to harden security against future attacks and reduce dwell time for a potential infection.

Extended detection and response (XDR) is an approach to threat detection and response that provides holistic protection against cyberattacks, unauthorized access and misuse. XDR breaks down traditional security silos to deliver detection and response across all data sources.

XDR is a Software as a Service (Saas) based security threat detection and incident response tool that natively integrates multiple security products into a cohesive security system. XDR can be considered a next evolution of Endpoint Detection and Response (EDR), which optimizes threat detection, investigation, response, and hunting in real time. XDR unifies security-relevant endpoint detections with telemetry from security and business tools such as Network Analysis and Visibility (NAV), email security, identity and access management, cloud security, and more. It is a cloud-native platform built on big data infrastructure to provide security teams with flexibility, scalability, and opportunities for automation.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a computer network architecture having a web application and employing a security agent service for preventing security attacks.

FIG. 2 is a schematic illustration showing a web application and a security agent employed to provide security in relation to script potentially processed by the web application.

FIG. 3 is a schematic illustration showing a security analytics engine working in conjunction with an Extended Detection and Response (XDR) service for preventing security attacks to a device using a web application.

FIG. 4 is a schematic illustration showing XDR architecture in greater detail working in conjunction with an analytics engine for providing cyber security services.

FIG. 5 is a schematic illustration of analytics engine logic for implementing security services in a networking system employing web applications.

FIGS. 6A-6B illustrate a method according to an embodiment for providing enhanced cyber security in a network architecture employing a web application.

FIG. 7 illustrates a computing system diagram illustrating a configuration for a data center that can be utilized to implement aspects of the technologies disclosed herein.

FIG. 8 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

Embodiments described herein provide techniques for protecting services containing web applications from malicious attacks. A data flow is received from a web application. The received data flow includes a stack trace and a process. The stack trace is chained with the process to generate a data flow graph. A data lake is then accessed to determine whether the data flow graph is in the data lake. If the data flow graph does already exist the data lake, then the data flow can be considered safe. If the data flow graph is not already in the data lake, then a determination is made as to whether the data flow includes a command that accepts user input. If the process does not include a command that accepts user input, then the data flow can be considered safe and is added to the data lake. If it is determined that the data flow does include a command that accepts user input, then the data flow can be considered to be malicious and the process is terminated to protect the web application from a malicious attack.

Additionally, the techniques described herein may be performed by a system and/or device having non-transitory computer-readable media storing computer-executable instructions that, when executed by one or more processors, performs the method described above.

### EXAMPLE EMBODIMENTS

A web application is a computer program that is stored on a remote server and run by its users via a web browser. A web application is an advantageous form of software because the use of browsers allows the application to be compatible with most standard computers and operating systems. Moreover, the application does not take up memory on a computer's hard drive and is accessible from nearly any computer or device a person might use. Multiple users can use the same application at the same time, allowing for simultaneous participation. Although web applications always require a network connection, this limitation has lessened in importance as the Internet has become ever more ubiquitous.

Any service offered over the Internet can be considered to be a web application. Examples of web applications include online forms, shopping carts, video streaming, social media, games and e-mail. Given their superior accessibility, many web applications are developed for functions that previously did not require online access, such as work processing, spreadsheet creation, and the editing of graphics or videos.

Web applications generally use different programming languages for their user facing front ends (or “client sides”), which present information, and for the back ends (“server sides”), which store and retrieve that information. Scripts for applications' front ends are written in languages such as HTML, CSS, and JavaScript, as those are supported by most browsers. PHP and AS.NET are common choices for back ends. However, since web applications, unlike mobile applications, frequently lack standard development kits (SDK), developers' choices for programming their servers are less restricted.

Web applications have certain inherent cybersecurity vulnerabilities. Web application security is a branch of information security that deals specifically with the security of websites, web applications, and web services. At a high level, web application security draws on the principles of application security but applies them specifically to the internet and web systems. Web application security tools are specialized tools for working with HTTP traffic such as web application firewalls.

Some common security threats related to web applications include: broken access control: cryptographic failures: injection: insecure design: security misconfiguration; vulnerable and outdated components: identification and authentication failures: software and data integrity failures: security logging and monitoring failures; and server-side request forgery. Security testing techniques search for vulnerabilities or security holes in applications. These vulnerabilities leave applications open to exploitation. Ideally, security testing is implemented throughout the entire software development cycle so that vulnerabilities may be addressed in a timely and thorough manner.

There are many kinds of automated tools for identifying vulnerabilities in applications. Static Application Security Testing (SAST) analyzes source code for security vulnerabilities during an application's development. SAST can be utilized even before the application is in an executable state. As SAST has access to the full source code it is a white-box approach. This can yield more detailed results but can result in many false positives that need to be manually verified.

Dynamic Application Security Testing (DAST) automatically detects vulnerabilities by crawling and analyzing websites. This method is highly scalable, easily integrated and quick. DAST tools are well suited to dealing with low-level attacks such as injection flaws but are not well suited to detecting high-level flaws such as logic or business logic flaws.

Interactive Application Security Testing (IAST) assesses applications from within using software instrumentation. This combines the strengths of both SAST and DAST methods as well as providing access to code, HTTP traffic, library information, backend connections and configuration information. Some IAST products require the application to be attacked, while others can be used during normal quality assurance testing.

Runtime-Application Self-Protection (RASP) augments existing applications to provide intrusion detection and prevention from within an application runtime. Dependency scanners (also referred to as Software Composition Analysis) attempts to detect the usage of software components with known vulnerabilities. These tools can either work on-demand, such as during the source code build process, or periodically.

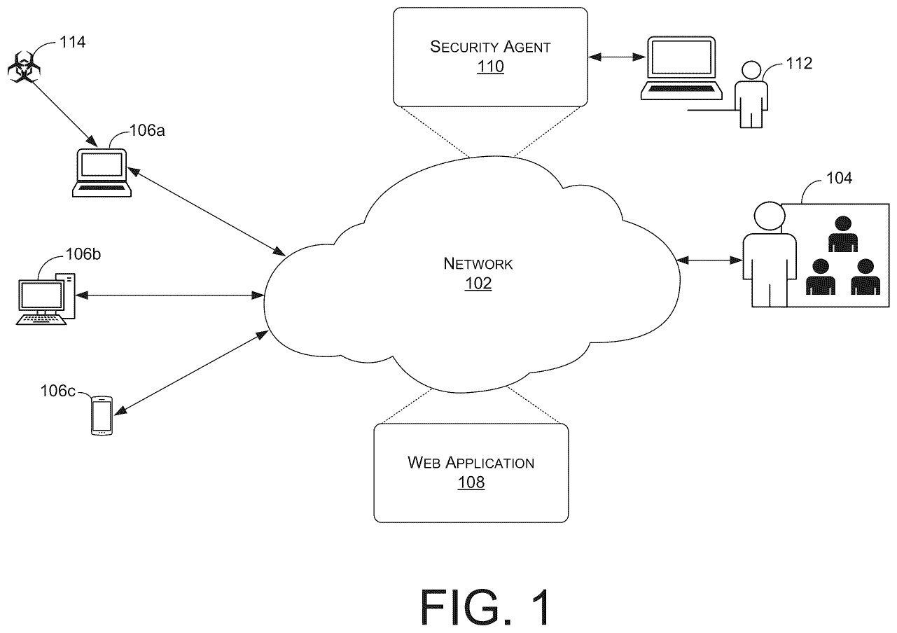

FIG. 1 is a schematic illustrating a computer network architecture 100 employing a network 102, which can be a Wide Area Network (WAN) such as the Internet to provide network connectivity between various end devices and enterprises. In one embodiment, an enterprise 104 such as a business, government entity, campus, etc. can connect with various endpoint devices 106 via the network 102. The end devices 106 could be a laptop computer 106a, desktop computer 106b, mobile device 106c or any other network connected device.

The connectivity provided by the network 102 can provide access to Web Application 108. The various end devices 106 as well as the enterprise 104 can access the Web Application 108 to provide various services and functions that do not have to reside directly on the devices 106 or computers of the enterprise 104.

Prior to the availability of easy network connectivity such as the internet computer applications were stored locally on a device or on a server connected with the device. An application had its own pre-compiled client program which served as its user interface and had to be separately installed on each user's personal computer. An upgrade to the server-side code of the applications would typically also require an upgrade to the client-side code installed on each user workstation, adding to the support cost and decreasing productivity. In addition, both the client and server components of the application were usually tightly bound to a particular computer architecture and operating system and porting them to others was often prohibitively expensive for all but the largest applications.

In the 1990s client-side scripting languages such as JavaScript allowed programmers to add some dynamic elements to the user interface that ran on the client side. So, instead of sending data to the sever in order to generate an entire web page, the embedded scripts of the downloaded page can perform various tasks such as in put validation or showing or hiding parts of a page.

Later the “web application” concept was introduced. Applications providing services such as email started to make their client sides more interactive. A web page script is able to contact the server for storing and retrieving data without downloading an entire web page. Many web applications provide a multi-tiered approach. For example, a web browser can be the first tier. An engine using some dynamic web content technology can be the middle tier, and a database can be the third tier. The web browser can send a request to the middle tier, which services the request by making queries and updates against the database and generates a user interface.

Security breaches using web applications are a concern because it can involve both enterprise information and private customer data. Protecting these assets is an important part of a web application design and there are some key operational areas that should be included in the development process. This can include processes for authentication, authorization, asset handling, input, and logging, and auditing.

In order to ensure security, the computer network architecture 100 can include a web-based Security Agent 110. The Security Agent 110, which will be described in greater detail herein below can include security logic such as Endpoint Detection Response (EDR) extended Detection and Response (XDR) and can include analytics engine logic for handling security threats related to security vulnerabilities of the Web Application 108. In some embodiments, the Security Agent 110 can be operated and maintained by one or more operators 112 who can monitor threats and respond accordingly.

In one example, a malicious threat 114 such as a cyber-attack can infiltrate an end user device 106 that is also accessing the Web Application 108. Security vulnerabilities related to the Web Application 108 can allow the malicious threat 114 to affect other devices 106 or even the enterprise 104. This can lead to problems such as ransom-ware attacks, loss of data, etc. The Security Agent 110 prevents such attacks by detecting and mitigating such attacks before they can cause any harm. The Security Agent 110 can accomplish this according to various embodiments that will be described in greater detail herein below.

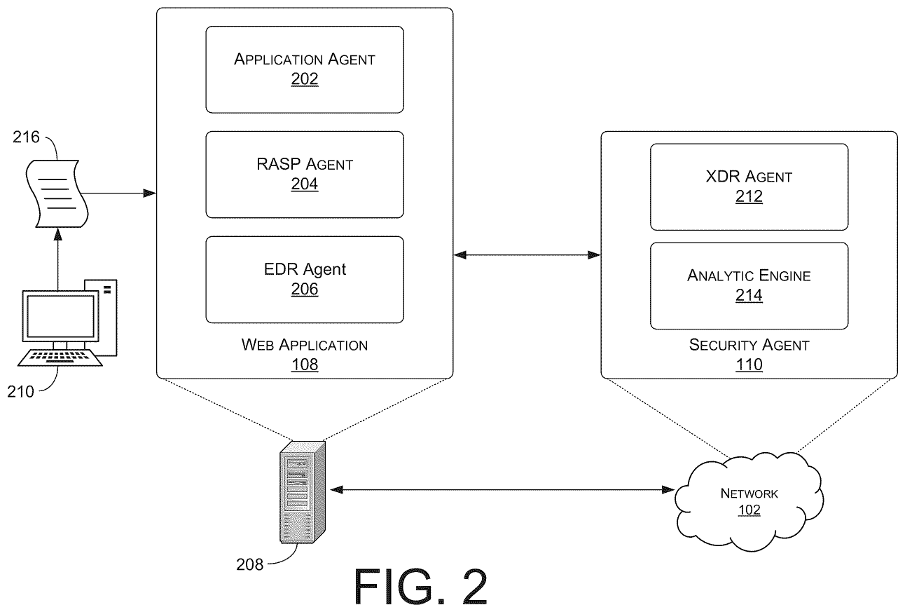

FIG. 2 is a schematic illustrating an interaction between a Web Application 108 and a Security Agent 110. The Web Application 108 can include logic and circuitry for providing an Application Agent 202. The Application Agent 202 can provide application services such as email, online forms, shopping carts, word processors, spreadsheets, video and photo editing, file conversion, file scanning or any number of other online application services. The Web Application 108 also includes circuitry and lotic for providing Run-time Application Self Protection Agent (RASP Agent 204) and also contains logic and circuitry for proving an Endpoint Detection and Response Agent (EDR Agent 206). The Web Application 108 can physically reside on one or more servers 208 which can be connected with the previously described network 102 such as the Internet where the Web Application 108 can be accessible by endpoint devices 210 connected over the network 102.

The Run-time Application Self Protection Agent (RASP Agent 204) provides security services that wrap around and protect the Application Agent 202, rather than merely providing a general network-level or endpoint-level defensive solution. RASP is a security technology that uses runtime instrumentation to detect and block computer attacks by taking advantage of information from inside the running software. The technology differs from perimeter-based protections such as firewalls, that can only detect and block attacks by using network information without contextual awareness. RASP technology improves the security of software by monitoring its inputs, and blocking those that could allow attacks, while protecting the runtime environment from unwanted changes and tampering. The RASP relies less on external devices like firewalls to provide runtime security protection. When a threat is detected, RASP can prevent exploitation and possibly take other actions, including terminating a user's session, shutting down the application, alerting security personnel and sending a warning to a user. RASP closes the gap left by application security testing and network perimeter controls, neither of which have enough insight into real-time data and event flows to either prevent vulnerabilities from slipping through the review process or block new threats that were unforeseen during development.

The EDR Agent provides Endpoint Detection and Response (EDR) to detect threats across the Web Application environment, investigating the entire lifecycle of the threat, and providing insights into what happened, how the threat got in, where it has been, what the threat is doing now, and what to do about the threat. By containing the threat at the endpoint, EDR helps to eliminate the threat before it can spread.

EDR is a cybersecurity technology that continually monitors an endpoint device (such as endpoint device 210) to mitigate malicious cyber threats. Endpoint detection and response technology is used to identify suspicious behavior and advanced persistent threats on endpoints in an environment, and alert administrators accordingly. It does this by collecting and aggregating data from endpoints and other sources. That data may or may not be enriched by additional cloud analysis. EDR solutions are primarily an alerting tool rather than a protection layer, but functions may be combined depending on the vendor. The data may be stored in a centralized database or forwarded to a Security Information and Event Management (SEIM) tool. Capabilities of the EDR Agent 206 can include the monitoring of endpoints in both the online and offline mode, responding to threats in real-time, increasing visibility and transparency of user data, detecting stored endpoint events and malware injections, creating blacklists and whitelists, and integrating with other technologies.

The Security Agent 110, includes an XDR Agent 212 and an Analytic Engine 214 which work together to provide enhanced cyber-security to the Web Application 108, as will be described in greater detail herein below.

The XDR Agent 212 provides enhanced cybersecurity services to the Web Application 108. The XDR Agent 212 can work in conjunction with the RASP Agent 204 and EDR Agent 206 to provide this enhanced cyber-security service. XDR is a consolidation of tools and data that provides extended visibility, analysis, and response across endpoints, workloads, users, and networks. XDR unifies endpoint and workload security capabilities with critical visibility, reducing blind spots, detecting threats faster, and automating remediation via authoritative context across these domains.

XDR works by collecting and correlating data across various network points such as servers, email, cloud workloads, and endpoints. The data is then analyzed and correlated, lending it visibility and context, and revealing advanced threats. Thereafter, the threats are prioritized, analyzed and sorted to prevent security collapses and data loss. The XDR system helps organizations to have a higher level of cyber awareness, enabling cyber security teams to identify and eliminate security vulnerabilities.

XDR improves malware detection and antivirus capabilities over endpoint detection and response (EDR) alone. XDR improves on the EDR capabilities to deploy high-grade security solutions by utilizing current technologies which proactively identify and collect security threats and employs strategies to detect future cyber security threats. It is an alternative to reactive endpoint protection solutions such as EDR and network traffic analysis (NTA).

When the Web Application 108 receives a data flow or script 216, from the endpoint device 210, the data flow 216 is first captured and processed by the EDR Agent 206 and the RASP Agent 204. The RASP Agent 204 and EDR agent work in conjunction with the XDR Agent 212 and the Analytic Engine 214 to determine whether the data flow 216 represents a threat to the Web Application 108 or to other devices (not shown) that might be implementing the Web Application.

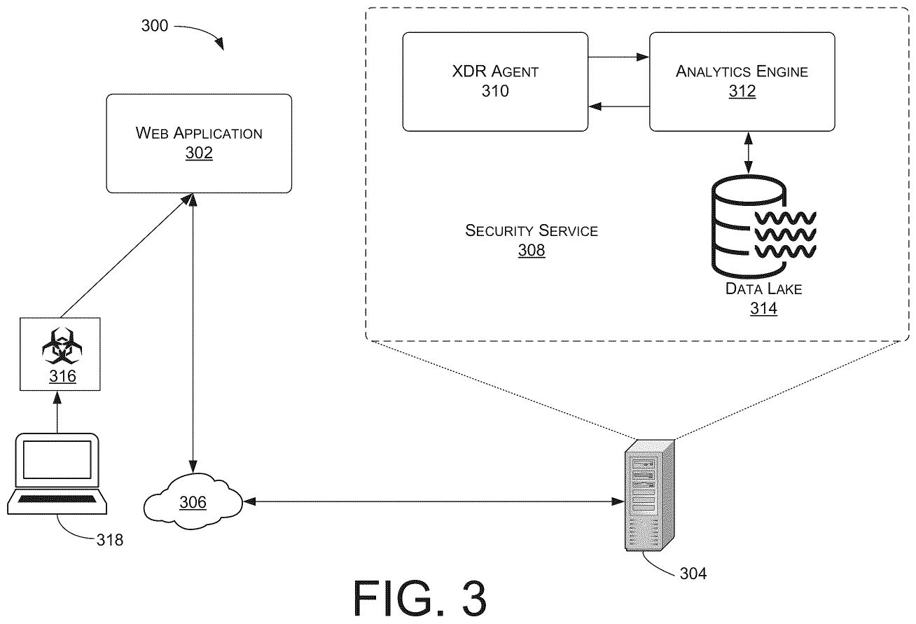

FIG. 3 shows a schematic of a network environment 300 providing cyber-security services for use with a Web Application 302. The Web Application 302 can be connected with one or more servers 304 via a Wide Area Network WAN 306 such as the Internet. The one or more servers 304 provide a Security Service 308 including an XDR Agent 310 and an Analytics Engine 312. In one embodiment, the XDR Agent 310 and the Analytics Engine 312 can reside on the same server or servers. In another embodiment, the XDR Agent 310 and the Analytics Engine 312 can reside on different servers that and can be connected over a computer network which can be a Wide Area Network (WAN) such as the Internet. The Security Service 308 also includes access to a Data Lake 314 for storing valid safe data flows as will be seen. In one embodiment, the Data Lake 314 can reside on the same server or servers 304 as one or more of the XDR Agent 310 and Analytics Engine 312. In another embodiment, the Data Lake 314 can reside on a different server or servers than the XDR Agent and/or Analytics Engine. In one embodiment, the Data Lake 314 can be cloud-based residing in a network such as the WAN 306.

In an in an ever more dangerous networking environment, it can be possible for the Web Application 302 to receive a possibly malicious data flow 316. The data flow 316 can come from an end-device 318. The end-device 318 could send the threat intentionally or could itself be infected by a malicious third party. The Web Application 302 accesses the Security Service 308 via WAN 306 and through connection with the one or more servers 304. The Security Service protects the Web Application 302 by determining whether the data flow 316 is in fact a threat or is benign. If the data flow 316 is determined to be a threat, the Security Service will cause the Web Application 302 to terminate any script from the data flow 316. If the Security Service 308 determines that the data flow 316 is not a threat, the Web Application will be able to process the data flow 316 normally, and a record of the data flow will be stored in the Data Lake 314.

When the Security Service 308 receives notice of the data flow 316, the XDR Agent 310 will analyze the data flow 316 to determine whether the data flow 316 is a threat. The XDR Agent includes a Runtime Application Self-Protection (RASP) agent that instruments the Web Application 302 and traces the invocation of functions in the Web Application 302. If the Web Application 302 invokes program execution functions such as eval( ), passthrough( ), Shell_exec( ), System( ), proc_open( ), java.lang.Runtime.exec( ) etc., the stack trace and process id (PID) of the process that is getting spawned at the operating system of the Web Application 302 will be captured by the RASP agent. The PID and the stack trace will be sent to the XDR Agent 310. At the operating system, a system agent will capture the PID and process tree of the data flow 316 from the Web Application 302. The PID and process tree will be sent to the XDR Agent 310.

If the PID from the RASP is the same as the process ID from the operating system, then the process spawned by the Web Application 302 will be chained with the process tree, which the system agent has captured to construct the data flow graph. The nodes of the data flow graph will contain the name of the function that gets invoked. Once the data flow is constructed, arguments of the functions will be removed to normalize it.

Once the data flow graph is constructed, the Data Lake 314 will be checked to determine whether the data flow 316 exists in the Data Lake 314. If the flow does exist in the Data Lake 314, then the data flow 316 will be considered safe, and further security processing can stop. If, however, the data flow 316 does not exist in the Data Lake 314, then the data flow 316 will be considered to be anomalous, and the data flow will be sent to the Analytics Engine 312.

The Analytics Engine 312 will parse the data flow 316 and check to determine whether the code path in the operating system is coming from methods that accept user inputs such as GET, POST, and HTTP headers. If the data flow does come from methods that accept user inputs a verdict of “remote code execution” will be given for the data flow. The PID will be sent to an EDR agent for termination and the IP address from the GET request originated will be sent to RASP to drop the connection and the data flow graph will not be stored in the data lake. On the other hand, if the data flow does not come from a method that accepts user input, the data flow graph will be sent to the Data Lake 314 for storage.

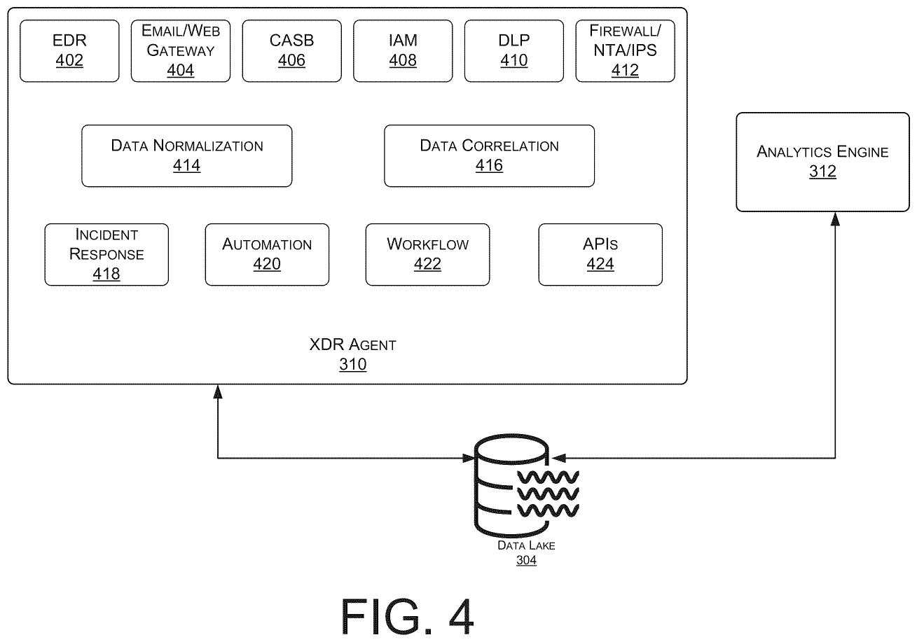

FIG. 4 is a schematic describing an embodiment of the XDR Agent 310 in greater detail. The XDR Agent 310 can include: an Endpoint Detection and Response (EDR Agent 402); and Email/Web Gateway 404: a Cloud Access Security Broker (CASB) 406: an Algorithms for Intrusion Measurement (AIM) Agent 408: a Data Loss Prevention agent (DLP agent 410); and a Firewall/Network Traffic Analysis (NTA)/Intrusion Prevention System (IPS) Agent 412.

The XDR Agent 310 can also include a Data Normalization module 414: Data Correlation module 416: Incident Response module 418: Automation module 420: Workflow Module 422; and an Application Programming Interface (API) module 424.

In current hybrid, multi-vendor, multi-vector landscapes, complexity is a challenge. Security teams must protect an ever-expanding exco-system, running operations across dozens of tools with inconsistent integration. Internet of Things (IoT), Web Applications, and hybrid work environments have led to an expanded attack surface. Phishing, malware, and ransomware are doubling and even tripling year over year. At the same time, businesses are more hyperconnected than ever before. A security breach to one company can impact a company's suppliers, partners, customers and even whole sectors of the economy. This environment requires security resilience, including the ability to protect the integrity of every aspect of a business to withstand unpredictable threats or changes and emerge stronger.

With threats becoming increasingly sophisticated, traditional detection and response models, built upon self-contained point security solutions are inadequate. XDR can help to overcome these challenges. Extended Detection and Response (XDR) is an incident detection and response tool. XDR solutions automatically collect and correlate telemetry from multiple security tools, apply analytics to detect malicious activity, and then responds to and remediate threats. Effective XDR solutions are comprehensive, correlating data across all vectors, including email, endpoints, servers, cloud workloads, networks and web applications, enabling visibility and context across a computer environment into even the most advanced threats.

XDR allows teams to detect the most sophisticated threats with event correlation and multi-vendor detections across network, cloud, endpoint and web applications. XDR also reduces alert fatigue by enabling teams to prioritize threats based on impact and elevates productivity with task automation so that teams can make more efficient use of security resources. It also allows organizations to build security resilience by closing security gaps and anticipating threats through actionable intelligence.

XDR provides prioritized and actionable telemetry by providing visibility and depth of insight. Many sophisticated threats do not only attack endpoint devices or a network alone. They can attack across a variety of vectors, including web applications such as email, identity management, sandboxing and firewalls. XDR provides a broad range of telemetry and quality of data that can inform XDR outcomes and provide a holistic and complete view of what is happening across an environment. In addition to gathering insights, XDR provides incident management. XDR provides a risk-based prioritization so that security teams can prioritize incidents by greatest material risk.

The Endpoint Detection and Response Agent (EDR Agent) 402 collects and correlates data across various network points such as endpoints and web applications. The threats are prioritized, analyzed, and sorted to prevent security collapses and data loss. The Email/Web Gateway 404 is deployed at the boundaries of a network to monitor and stop malicious traffic from entering an organization and blocks users from accessing malicious or suspicious web resources. The Email/Web Gateway 404 can provide URL filtering, virus and malware detection, data leak prevention, and application-level control.

The Cloud Access Security Broker (CASB) agent 406 secures data flowing to and from in-house IT architectures and cloud vendor environments using an organization's security policies. The CASB agent 406 protects enterprise systems against cyberattacks through malware prevention and provides data security through encryption, making data streams unreadable to outside parties.

The Algorithm for Intrusion Management (AIM) agent 408 manages and prioritizes threats. The Data Loss Prevention agent (DLP agent 410) performs both content inspection and contextual analysis of data sent via messaging applications such as email and instant messaging sent over a network and used on a managed endpoint device and at rest in on-premises file servers or in web applications and cloud storage. The DLP agent 410 executes responses based on policy and rules defined to address the risk of inadvertent or accidental leaks or exposure of sensitive data outside authorized channels.

The Firewall/NTA/IPS agent 412 provides Firewall services, Network Traffic Analysis (NTA) and Intrusion Prevention System (IPS) services. NTA, is a method for monitoring network availability and activity to identify anomalies, including security and operational issues. Common use cases for NTA include: collecting a real-time and historical record of what is happening in a network: detecting malware such as ransomware activity; detecting the use of vulnerable protocols and ciphers: troubleshooting a slow network; and improving internal visibility and eliminating blind spots. IPS is a network security tool that continuously monitors a network for malicious activity and takes action to prevent it, including reporting, blocking, or dropping the threat when it does occur.

The Data Normalization module 414 organizes the data collected by the XDR Agent 310 and normalizes the data to appear similar across all records and fields. This increases the cohesion of data types leading to cleansing, lead generation, and higher quality data. The Data Correlation module 416 is a statistical measurement tool that expresses the extent to which variables of the data are related such that they can change together. It can be used as a tool for describing relationships between and among the collected data.

The Incident Response Agent identifies a response to be taken in an event that a security threat is identified. The goal of incident response is to enable the enterprise to quickly detect and halt attacks, minimizing damage and preventing future attacks of the same type. The Automation module 420 automates the management of all of the other features and agents of the XDR Agent 310, minimizing the work required of security managers. The Workflow Module 422 manages the workflow across the various agents of the XDR Agent 310 to maximize efficiency.

The Application Programming Interface (API) module 424 provides an interface for programmers and security managers to access and reconfigure the various described agents of the XDR Agent 310. In one embodiment, the API module 424 can be a Graphic User Interface (GUI). The XDR Agent 310 can work in conjunction with the Analytics Engine to store and retrieve data regarding threats and data flows in the Data Lake 314.

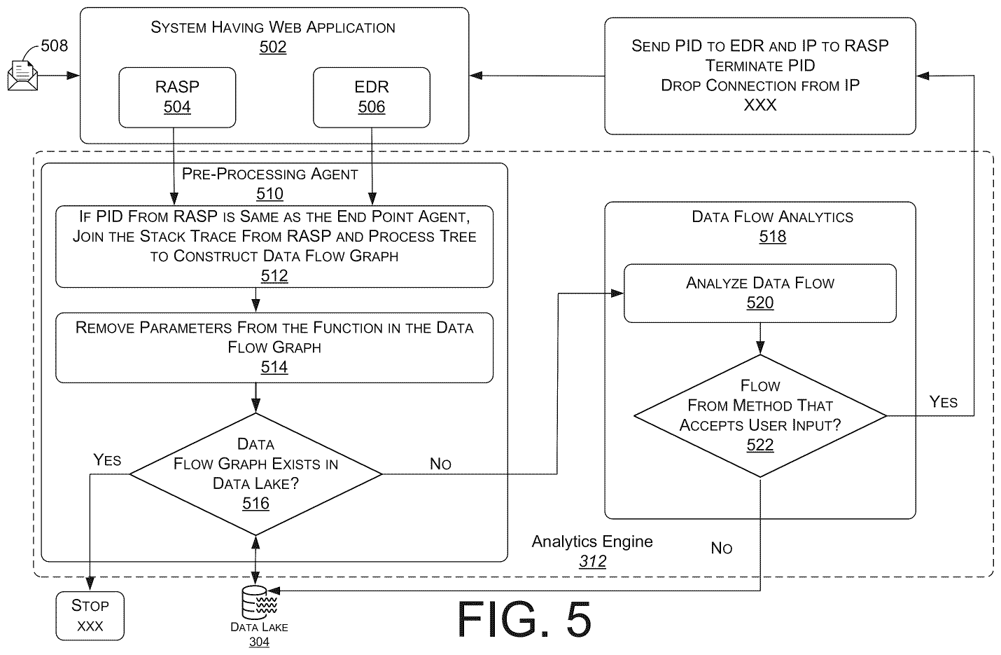

FIG. 5 is a schematic illustrating a logical process flow for implementing the Analytics Engine 312 for providing security to a system employing a web application. The Analytics Engine 312 works in conjunction with a System Having a Web Application 502. The System Having a Web Application 502 can be a system residing in one or more servers that may be a cloud-based system residing on one or more servers connected with a WAN network such as the Internet. The System Having a Web Application 502 has a Run-time Application Self-Protection agent (RASP agent 504) and an Endpoint Detection and Response agent 506.

The System Having a Web Application 502 can receive a data flow 508 from another device connected over the computer network or WAN. The RASP agent 504 sends a stack trace and process ID to a Pre-Processing Agent 510 of the Analytics Engine 312 in response to determining that program execution functions are invoked by the data flow 508. In addition, the EDR agent 506 sends a Process Identification (PID) and a process tree for the data flow 508 to the Pre-Processing Agent 510 of the Analytics Engine 312.

If the PID from the RASP agent 504 matches the PID from the EDR agent 506, the Pre-Processing Agent performs operations to join the stack trace from the RASP with the Process Tree from the EDR agent 506, which the System Having a Web Application 502 has captured, to construct a Data Flow Graph 512. The Pre-Processing Agent 510 then removes parameters from the function in the Data Flow Graph. The nodes of the data flow graph will contain the name of the function which gets invoked. Once the data flow graph is constructed, arguments of the functions will be removed to normalize it 514. The method which accepts user input Program execution function, invoked in the operating system will be the generic format to store the data at XDR in a normalized manner.

Once the data flow graph is constructed, the Data Lake 314 is accessed to determine whether the data flow exists 516 in the Data Lake 314. If yes, the data flow graph does exist in the Data Lake 314, then the process security processing can terminate. If no, the data flow graph does not exist in the Data Lake 314, then Data Flow Analytics 518 are accessed for further processing of the data flow.

An Analysis Agent 520 analyzes the data flow to determine whether the data flow is from a method that accepts user input. A flow having code such as GET, POST, etc., indicates that the flow is from a method that accepts user input. A determination 522 is made as to whether the flow is from a method that accepts user input. If the answer is no, the flow is not from a method that accepts user input, then the flow is stored in the Data Lake 314. In response to determining that the answer is yes, the flow is from a method that accepts user input, then a series of operations 524 are performed to protect the System Having a Web Application 502. The operations 524 can include: sending the PID to EDR and IP to RASP agent 504: terminating the PID; and dropping the connection from the Internet Protocol IP.

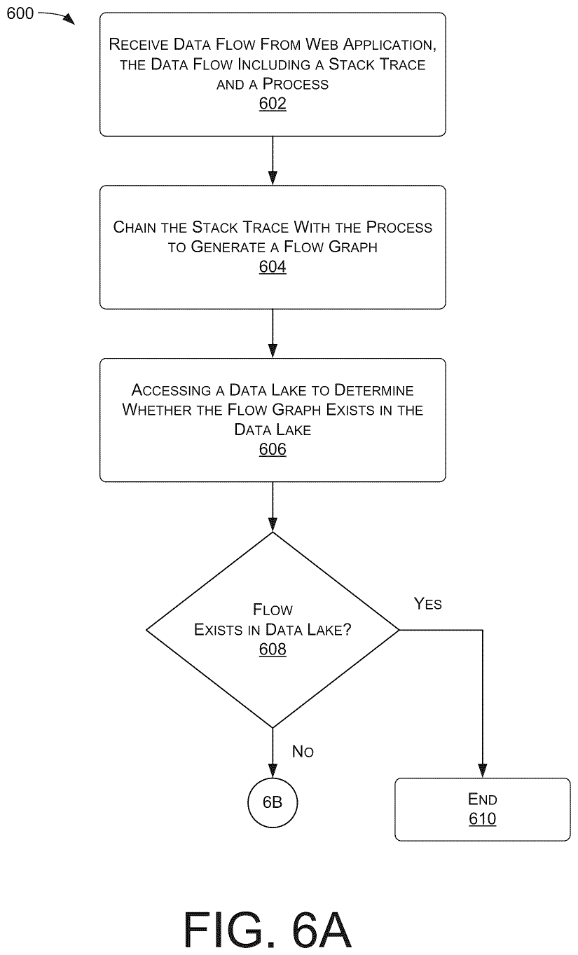

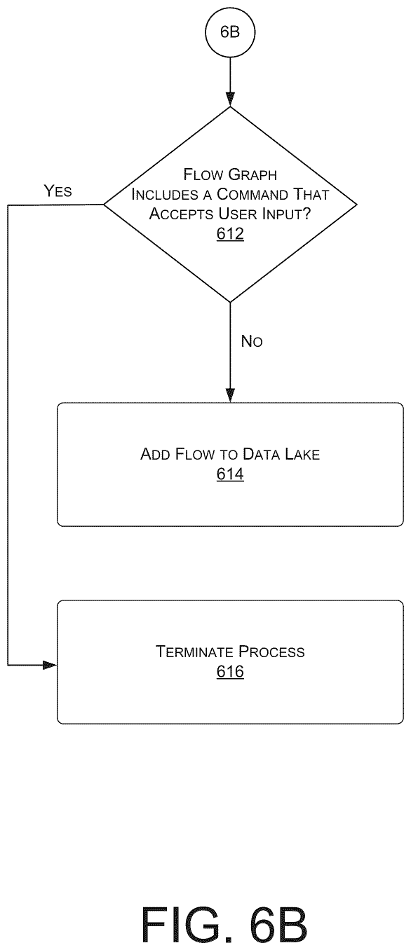

FIGS. 6A and 6B illustrate a flow diagram of an example methods 600 that illustrate aspects of the functions performed at least partly by the devices in computer architectures as described in FIGS. 1-5. The logical operations described herein with respect to FIGS. 6A and 6B may be implemented (1) as a sequence of computer-implemented acts or program modules running on a computing system and/or (2) as interconnected machine logic circuits or circuit modules within the computing system. By way of example, operations described herein can be performed by a Web Application 108 in conjunction with a Security Agent 110 as described in FIG. 2. The operations can also be performed by the Security Service 308 described with reference to FIG. 3, or by the Analytics Engine 312 described with reference to FIG. 5.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 6A and 6B and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

With reference to FIG. 6A, a method 600 includes receiving a data flow from a web application or from a service having a web application 602. The data flow includes a stack trace and a process. The data flow can be received by an analytics engine as described above with reference to FIGS. 4-5. The stack trace and process from the data flow are chained to generate a flow graph 604. Parameters from the function in the data flow graph can be removed from the flow graph. A data lake is accessed 606 to determine whether the data flow graph exists in the data lake. A determination 608 is made as to whether the flow exists in the data lake. If the answer to that determination is yes, the data flow does exist in the data lake, then the process can end 610. A determination that the data flow graph is already in the data lake indicates that the data flow is safe and is not a threat.

If the determination 608 as to whether the data flow graph is in the data lake is that no, the data flow graph is not already in the data lake, then (with reference to FIG. 6B) a determination 612 is made as to whether the data flow graph includes a command that accepts user input. If the data flow graph includes commands such as “GET”, Post, etc. then it can be determined that the data flow graph includes a command that accepts user input. If the answer to the determination 612 is no, the flow graph does not include a command that accepts user input, then the data flow graph is added to the data lake 614. On the other hand, if the answer to the determination 612 is yes, the flow graph does include a command that accepts user input, then the process is terminated 616. A determination that the data flow graph does include commands that accept user input indicates that the data flow is malicious and needs to be terminated. In addition to terminating the process the Process ID of the data flow can be sent to an Extended Detection and Response agent, and the connection form Internet Protocol (IP) can be dropped.

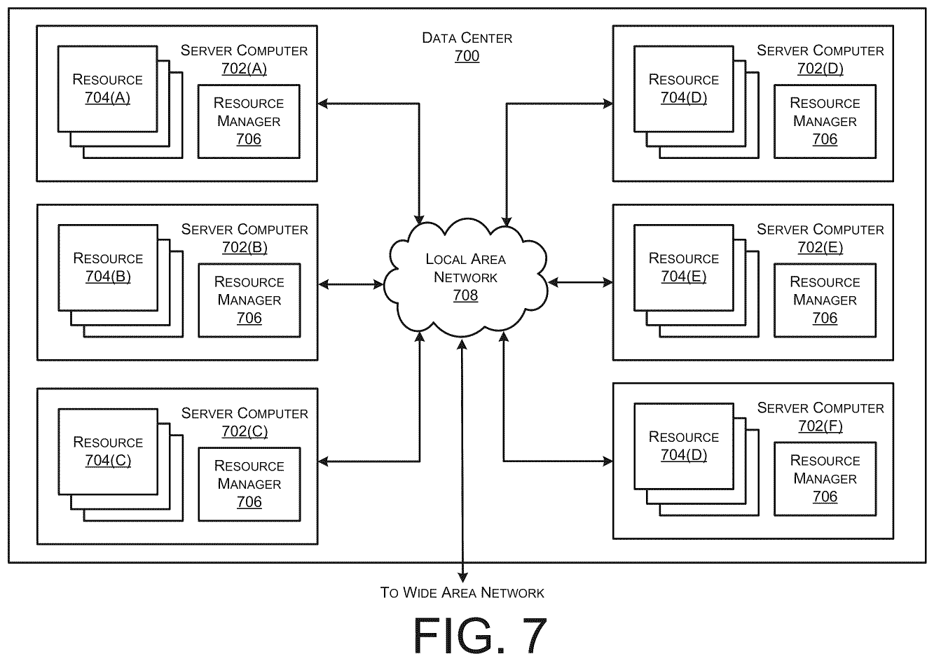

FIG. 7 is a computing system diagram illustrating a configuration for a data center 700 that can be utilized to implement aspects of the technologies disclosed herein. The example data center 700 shown in FIG. 7 includes several server computers 702A-702F (which might be referred to herein singularly as “a server computer 702” or in the plural as “the server computers 702”) for providing computing resources. In some examples, the resources and/or server computers 702 may include, or correspond to, the any type of networked device described herein. Although described as servers, the server computers 702 may comprise any type of networked device, such as servers, switches, routers, hubs, bridges, gateways, modems, repeaters, access points, etc.

The server computers 702 can be standard tower, rack-mount, or blade server computers configured appropriately for providing computing resources. In some examples, the server computers 702 may provide computing resources 704 including data processing resources such as VM instances or hardware computing systems, database clusters, computing clusters, storage clusters, data storage resources, database resources, networking resources, and others. Some of the servers 702 can also be configured to execute a resource manager 706 capable of instantiating and/or managing the computing resources. In the case of VM instances, for example, the resource manager 706 can be a hypervisor or another type of program configured to enable the execution of multiple VM instances on a single server computer 702. Server computers 702 in the data center 700 can also be configured to provide network services and other types of services.

In the example data center 700 shown in FIG. 7, an appropriate LAN 708 is also utilized to interconnect the server computers 702A-702F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 700, between each of the server computers 702A-702F in each data center 700, and, potentially, between computing resources in each of the server computers 702. It should be appreciated that the configuration of the data center 700 described with reference to FIG. 7 is merely illustrative and that other implementations can be utilized.

In some examples, the server computers 702 may each execute one or more application containers and/or virtual machines to perform techniques described herein.

In some instances, the data center 700 may provide computing resources, like application containers, VM instances, and storage, on a permanent or an as-needed basis. Among other types of functionality, the computing resources provided by a cloud computing network may be utilized to implement the various services and techniques described above. The computing resources 704 provided by the cloud computing network can include various types of computing resources, such as data processing resources like application containers and VM instances, data storage resources, networking resources, data communication resources, network services, and the like.

Each type of computing resource 704 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 704 not mentioned specifically herein.

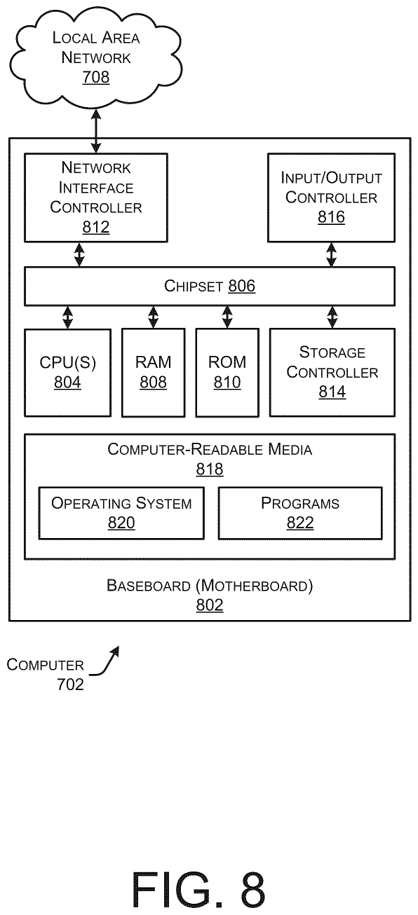

The computing resources 704 provided by a cloud computing network may be enabled in one embodiment by one or more data centers 700 (which might be referred to herein singularly as “a data center 700” or in the plural as “the data centers 700”). The data centers 700 are facilities utilized to house and operate computer systems and associated components. The data centers 700 typically include redundant and backup power, communications, cooling, and security systems. The data centers 700 can also be located in geographically disparate locations. One illustrative embodiment for a data center 700 that can be utilized to implement the technologies disclosed herein will be described below with regard to FIG. 8.

FIG. 8 shows an example computer architecture for a server computer 702 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The server computer 702 may, in some examples, correspond to a physical server, and may comprise networked devices such as servers, switches, routers, hubs, bridges, gateways, modems, repeaters, access points, etc.

The computer 702 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 702.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 702. The chipset 806 can further provide an interface to a computer-readable storage medium such as a read-only memory (“ROM”) 810 or non-volatile RAM (“NVRAM”) for storing basic routines that help to startup the computer 702 and to transfer information between the various components and devices. The ROM 810 or NVRAM can also store other software components necessary for the operation of the computer 702 in accordance with the configurations described herein.

The computer 702 can operate in a networked environment using logical connections to remote computing devices and computer systems through a network, such as the network 708. The chipset 806 can include functionality for providing network connectivity through a NIC 812, such as a gigabit Ethernet adapter. The NIC 812 is capable of connecting the computer 702 to other computing devices over the network 708 (and/or network 102). It should be appreciated that multiple NICs 812 can be present in the computer 702, connecting the computer to other types of networks and remote computer systems.

The computer 702 can be connected to a storage device 818 that provides non-volatile storage for the computer. The storage device 818 can store an operating system 820, programs 822, and data, which have been described in greater detail herein. The storage device 818 can be connected to the computer 702 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 702 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computer 702 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 702 can further read information from the storage device 818 by detecting the physical states or characteristics of one or more particular locations within the physical storage units.

In addition to the mass storage device 818 described above, the computer 702 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 702. In some examples, the operations performed by devices in a distributed application architecture, and or any components included therein, may be supported by one or more devices similar to computer 702. Stated otherwise, some or all of the operations performed by the systems or devices such as enterprise 104, device 106, Web Application 108, Security Agent 110, one or more servers 208, Security Agent 110, one or more servers 304 and or any components included therein, may be performed by one or more computer devices 702 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computer 702. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computer 702.

In one embodiment, the storage device 818 or other computer-readable storage media is encoded with computer-executable instructions which, when loaded into the computer 702, transform the computer from a general-purpose computing system into a special-purpose computer capable of implementing the embodiments described herein. These computer-executable instructions transform the computer 702 by specifying how the CPUs 804 transition between states, as described above. According to one embodiment, the computer 702 has access to computer-readable storage media storing computer-executable instructions which, when executed by the computer 702, perform the various processes described above with regard to FIGS. 1-6. The computer 702 can also include computer-readable storage media having instructions stored thereupon for performing any of the other computer-implemented operations described herein.

The computer 702 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 702 might not include all of the components shown in FIG. 8, can include other components that are not explicitly shown in FIG. 8, or might utilize an architecture completely different than that shown in FIG. 8.

As described herein, the computer 702 may comprise one or more of a router, load balancer and/or server. The computer 702 may include one or more hardware processors 804 (processors) configured to execute one or more stored instructions. The processor(s) 804 may comprise one or more cores. Further, the computer 702 may include one or more network interfaces configured to provide communications between the computer 702 and other devices, such as the communications described herein as being performed by the router, load balancer and/or server. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 822 may comprise any type of programs or processes to perform the techniques described in this disclosure for providing a distributed application load-balancing architecture that is capable of supporting multipath transport protocol. That is, the computer 702 may comprise any one of the routers, load balancers, and/or servers. The programs 822 may comprise any type of program that cause the computer 702 to perform techniques for communicating with other devices using any type of protocol or standard usable for determining connectivity.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for preventing remote code execution attacks, the method comprising:
receiving a data flow from a web application, the data flow including a stack trace and a process;
chaining the stack trace with the process to generate a flow graph;
accessing a data lake to determine whether the flow graph exists in the data lake;
in response to determining that the flow graph does not exist in the data lake, determining whether the flow graph includes a command that accepts user input;
in response to determining that the flow graph does include a command that accepts user input, terminating the process; and
in response to determining that the flow graph does not include a command that accepts user input, adding the flow graph to the data lake.

2. The method as in claim 1 further comprising, in response to determining that the process includes a command that accepts user input, sending instruction to an extended detection and response service for termination.

3. The method as in claim 1, wherein the data flow is received from a system that includes endpoint detection response.

4. The method as in claim 1, wherein the data flow is received from a system that includes run-time application self-protection.

5. The method as in claim 1, wherein terminating the process further includes sending a process ID to an endpoint detection and response service.

6. The method as in claim 1, wherein chaining the stack trace with the process to generate a process flow further comprises:
implementing a runtime application self-protection agent to instrument the web application and trace an invocation of functions in the web application and sending a process ID to an extended detection and response agent;
implementing an operating system to capture the process ID and sending the process ID to the extended detection and response agent; and
in response to determining that the process ID sent to the extended detection and response agent by the runtime application self-protection agent matches the process ID sent to the extended detection and response agent by the operating system, chaining the process of the data flow with a process tree to construct the flow graph.

7. The method as in claim 6 further comprising, in response to determining that the flow graph does include a command that accepts user input sending the process ID to an endpoint detection and response agent for termination and sending an internet protocol address of the data flow to the runtime application self-protection agent to drop connection.

8. A security agent comprising:
one or more processors; and
one or more non-transitory computer-readable media storing computer-executable instructions that, when executed by the one or more processors, cause the one or more processors to perform operations comprising:
receiving a data flow from a web application, the data flow including a stack trace and a process;
chaining the stack trace with the process to generate a flow graph;
accessing a data lake to determine whether the flow graph exists in the data lake;
in response to determining that the flow graph does not exist in the data lake, determining whether the flow graph includes a command that accepts user input;
in response to determining that the flow graph does include a command that accepts user input, terminating the process; and
in response to determining that the flow graph does not include a command that accepts user input, adding the flow graph to the data lake.

9. The security agent as in claim 8 further comprising, in response to determining that the process includes a command that accepts user input, sending instruction to an extended detection and response service for termination.

10. The security agent as in claim 8, wherein the data flow is received from a system that includes endpoint detection response.

11. The security agent as in claim 8, wherein the data flow is received from a system that includes run-time application self-protection.

12. The security agent as in claim 8, wherein terminating the process further includes sending a process ID to an endpoint detection and response service.

13. The security agent as in claim 8, wherein chaining the stack trace with the process to generate a process flow further comprises:
implementing a runtime application self-protection agent to instrument the web application and trace an invocation of functions in the web application and sending a process ID to an extended detection and response agent;
implementing an operating system to capture the process ID and sending the process ID to the extended detection and response agent; and
in response to determining that the process ID sent to the extended detection and response agent by the runtime application self-protection agent matches the process ID sent to the extended detection and response agent by the operating system, chaining the process of the data flow with a process tree to construct the flow graph.

14. The security agent as in claim 13, further comprising, in response to determining that the flow graph does include a command that accepts user input sending the process ID to an endpoint detection and response agent for termination and sending an internet protocol address of the data flow to the runtime application self-protection agent to drop connection.

15. One or more non-transitory computer-readable media storing computer-executable instructions that, when executed by one or more processors, cause the one or more processors to perform operations comprising:
receiving a data flow from a web application, the data flow including a stack trace and a process;
chaining the stack trace with the process to generate a flow graph;
accessing a data lake to determine whether the flow graph exists in the data lake;
in response to determining that the flow graph does not exist in the data lake, determining whether the flow graph includes a command that accepts user input;
in response to determining that the flow graph does include a command that accepts user input, terminating the process; and
in response to determining that the flow graph does not include a command that accepts user input, adding the flow graph to the data lake.

16. The one or more non-transitory computer-readable media as in claim 15 further comprising, in response to determining that the process includes a command that accepts user input, sending instruction to an extended detection and response service for termination.

17. The one or more non-transitory computer-readable media as in claim 15, wherein the data flow is received from a system that includes endpoint detection response.

18. The one or more non-transitory computer-readable media as in claim 15, wherein the data flow is received from a system that includes run-time application self-protection.

19. The one or more non-transitory computer-readable media as in claim 15, wherein terminating the process further includes sending a process ID to an endpoint detection and response service.

20. The one or more non-transitory computer-readable media as in claim 15, wherein chaining the stack trace with the process to generate a process flow further comprises:
implementing a runtime application self-protection agent to instrument the web application and trace an invocation of functions in the web application and sending a process ID to an extended detection and response agent;
implementing an operating system to capture the process ID and sending the process ID to the extended detection and response agent; and
in response to determining that the process ID sent to the extended detection and response agent by the runtime application self-protection agent matches the process ID sent to the extended detection and response agent by the operating system, chaining the process of the data flow with a process tree to construct the flow graph.
